(19) United States
(12) Patent Application Publication
(10) Pub. No.: US 2026/0243564 A1
(43) Pub. Date: Aug. 20, 2026

(54) METHOD FOR CALCULATING AMOUNT OF CHANGE IN CLEARANCE OF BLADE RING AND METHOD FOR ADJUSTING POSITION OF BLADE RING

(71) Applicant: MITSUBISHI HEAVY INDUSTRIES, LTD., Tokyo (JP)

(72) Inventors: Satoshi Kumagai, Tokyo (JP); Shunsuke Mizumi, Tokyo (JP); Koji Ishibashi, Tokyo (JP); Toshiki Chiba, Tokyo (JP)

(73) Assignee: MITSUBISHI HEAVY INDUSTRIES, LTD., Tokyo (JP)

(21) Appl. No.: 19/164,418

(22) PCT Filed: Jan. 9, 2024
(86) PCT No.: PCT/JP2024/000114

§ 371 Date: Sep. 11, 2025

(30) Foreign Application Priority Data
Mar. 27, 2023 (JP) 2023-050457

(51) Int. Cl. G01B 21/16; G01M 15/14

(52) U.S. Cl. CPC G01B 21/16; G01M 15/14

(57) ABSTRACT

The present invention pertains to a method for calculating the amount of change in a clearance of a blade ring and a method for adjusting the position of the blade ring. This method for calculating the amount of change in a clearance of a blade ring calculates the amount of change in a clearance in a vertical direction between an inner peripheral surface of the blade ring and an outer peripheral surface of a rotary shaft disposed inside the blade ring, the blade ring having a ring shape being configured by connecting a blade ring upper half part and a blade ring lower half part. The method comprises: a step for acquiring a displacement amount in a horizontal direction of the blade ring between a first state in which the blade ring upper half part is connected to the blade ring lower half part and a second state in which the blade ring upper half part has been removed from the blade ring lower half part; a step for calculating a second neutral axis of the blade ring in the second state on the basis of the displacement amount; and a step for calculating the amount of change in a clearance between the first state and the second state by comparing a first neutral axis of the blade ring in the first state with the second neutral axis.

### TECHNICAL FIELD

The present disclosure relates to a method for calculating an amount of a change in a clearance of a blade ring and a method for adjusting a position of a blade ring.

### BACKGROUND ART

A steam turbine as a rotary machine includes a casing, a rotor, a stator vane, and a rotor blade. In the casing, a rotor is rotatably supported inside the casing, and a plurality of rotor blades are fixed to the rotor at an interval in an axial direction. In addition, a plurality of stator vanes are fixed to the casing at an interval in the axial direction. The stator vane and the rotor blade are alternately disposed in the axial direction. A blade ring is fixed to an inner peripheral portion of a casing forming the casing. The blade ring is configured such that the plurality of stator vanes are provided between an outer ring and an inner ring at an interval in a circumferential direction, and has a ring shape. The blade ring is divided into two portions in an up-down direction, and is fastened by a bolt to have the ring shape.

The casing is disassembled in such a manner that an outer casing upper-half portion, an inner casing upper-half portion, and a blade ring upper-half portion are detached in this order, and the rotor is finally detached. The casing is assembled by using a reverse procedure of the disassembly. It is necessary to adjust a clearance between an outer peripheral surface of the rotor and an inner peripheral surface of the blade ring to have an appropriate value when the casing is assembled. In particular, in the blade ring, a strain may gradually increase with the lapse of time, and creep deformation may occur. Therefore, the casing is temporarily assembled in advance, and the clearance between the outer peripheral surface of the rotor and the inner peripheral surface of the blade ring is measured by using measurement equipment. As this technique, for example, there is a technique disclosed in PTL 1.

### CITATION LIST

### Patent Literature

[PTL 1] Japanese Patent No. 5501875

### SUMMARY OF INVENTION

### Technical Problem

According to the technique disclosed in PTL 1, the clearance between the outer peripheral surface of the rotor and the inner peripheral surface of the blade ring is measured by using the measurement equipment. In this case, it is necessary to carry out temporary assembly work of the casing or the blade ring, and it takes a long time for the temporary assembly work, thereby causing a problem in that work efficiency is poor.

The present disclosure is made to solve the above-described problems, and an object of the present disclosure is to provide a method for calculating an amount of a change in a clearance of a blade ring and a method for adjusting a position of a blade ring, which achieve improved workability in casing assembly work.

### Solution to Problem

According to the present disclosure, in order to achieve the above-described object, there is provided a method for calculating an amount of a change in a clearance of a blade ring, in which a blade ring having a ring shape is configured by connecting a blade ring upper-half portion and a blade ring lower-half portion and the amount of the change in the clearance in a vertical direction between an inner peripheral surface of the blade ring and an outer peripheral surface of a rotary shaft disposed inside the blade ring is calculated. The method includes a step of acquiring a displacement amount in a horizontal direction of the blade ring in a first state where the blade ring upper-half portion is connected to the blade ring lower-half portion and a second state where the blade ring upper-half portion is detached from the blade ring lower-half portion, a step of calculating a second neutral axis of the blade ring in the second state, based on the displacement amount, and a step of calculating the amount of the change in the clearance between the first state and the second state by comparing a first neutral axis of the blade ring in the first state with the second neutral axis.

In addition, according to the present disclosure, there is provided a method for adjusting a position of a blade ring. When a blade ring upper-half portion is assembled with a blade ring lower-half portion, a position of the blade ring in a vertical direction is adjusted, based on the amount of the change in the clearance which is calculated by the method for calculating an amount of a change in a clearance of a blade ring.

### Advantageous Effects of Invention

According to the method for calculating the amount of the change in the clearance of blade ring and the method for adjusting the position of the blade ring of the present disclosure, improved workability in casing assembly work can be achieved.

### BRIEF DESCRIPTION OF DRAWINGS

FIG. 1 is a schematic diagram showing an internal configuration of a steam turbine.

FIG. 2 is a schematic diagram showing an interior of a casing of the steam turbine.

FIG. 3 is a view for describing an amount of a change in a clearance which corresponds to creep deformation of a blade ring.

FIG. 4 is a flowchart showing a method for calculating the amount of the change in the clearance of the blade ring of a first embodiment.

FIG. 5 is a view for describing a method for calculating the amount of the change in the clearance of the blade ring.

FIG. 6 is a flowchart showing a method for adjusting a position of the blade ring.

FIG. 7 is a view for describing a method for calculating an amount of a change in a clearance of a blade ring of a second embodiment.

FIG. 8 is an enlarged view for describing the method for calculating the amount of the change in the clearance of the blade ring.

FIG. 9 is a flowchart showing a method for calculating the amount of the change in the clearance of the blade ring of the second embodiment.

### DESCRIPTION OF EMBODIMENTS

Hereinafter, preferred embodiments of the present disclosure will be described in detail with reference to the drawings. The present disclosure is not limited by the embodiments, and when a plurality of the embodiments are provided, the present disclosure also includes a configuration in which the respective embodiments are combined with each other. In addition, configuration elements in the embodiments include those which can be easily assumed by those skilled in the art, those which are substantially the same, and those which have a so-called equivalent scope.

### First Embodiment

### <Steam Turbine>

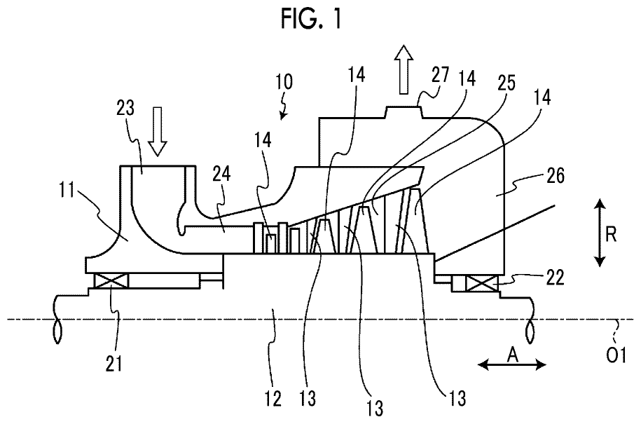

In a first embodiment, a method for calculating an amount of a change in a clearance of a blade ring and a method for adjusting a position of a blade ring will be described by applying the methods to a steam turbine as a rotary machine. However, the rotary machine is not limited to the steam turbine. FIG. 1 is a schematic diagram showing an internal configuration of the steam turbine.

In the first embodiment, the steam turbine will be described as the rotary machine. However, the rotary machine is not limited to the steam turbine, and may have a configuration in which a rotating body is rotatably supported with respect to a stationary body.

As shown in FIG. 1, a steam turbine (rotary machine) 10 includes a casing (stationary body) 11, a rotor (rotary shaft) 12, a stator vane 13, and a rotor blade 14.

The casing 11 has a hollow shape, and the rotor 12 is disposed along a horizontal direction inside the casing 11. The rotor 12 is rotatably supported around an axis O1 by bearings 21 and 22 provided in the casing 11 (or a foundation of a plant). A plurality of the stator vanes 13 are fixed to an inner peripheral portion of the casing 11 at an interval in an axial direction A of the rotor 12. A plurality of the rotor blades 14 are fixed to an outer peripheral portion of the rotor 12 at an interval in the axial direction A. The stator vanes 13 are disposed along a radial direction R of the rotor 12, and are disposed at an interval in a circumferential direction of the rotor 12. The rotor blades 14 are disposed along the radial direction R of the rotor 12, and are disposed at an interval in the circumferential direction of the rotor 12. The stator vanes 13 and the rotor blades 14 are alternately disposed in the axial direction A.

In the casing 11, a steam supply port 23 is provided in one end portion in the axial direction A. The steam supply port 23 communicates with a blade row section 25 in which the stator vane 13 and the rotor blade 14 are disposed, through a steam passage 24. The blade row section 25 communicates with an exhaust chamber 26. In the casing 11, a steam discharge port 27 is provided in the other end portion in the axial direction A. The steam discharge port 27 communicates with the exhaust chamber 26.

High-pressure steam is supplied to the blade row section 25 from the steam supply port 23 through the steam passage 24. The rotor 12 is driven and rotated via each of the rotor blades 14 by the steam passing through the plurality of stator vanes 13 and the plurality of rotor blades 14. A generator (not shown) is connected to the rotor 12, and the generator is driven by a driving force of the rotor 12. The steam driving each of the rotor blades 14 is discharged outward from the steam discharge port 27 through the exhaust chamber 26.

### <Blade Ring>

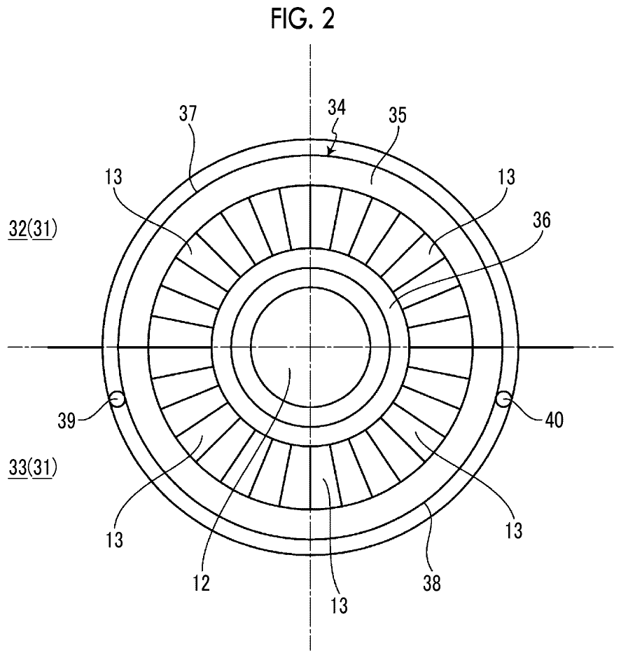

FIG. 2 is a schematic diagram showing an interior of a casing of the steam turbine.

As shown in FIG. 2, a casing 31 forming the casing 11 has a type divided into two portions in an up-down direction, and has a ring shape in which a casing upper-half portion 32 and a casing lower-half portion 33 are connected by a bolt (not shown). The blade ring 34 includes an outer ring 35, an inner ring 36, and the plurality of stator vanes 13. The plurality of stator vanes 13 are disposed at an interval in the circumferential direction between the outer ring 35 and the inner ring 36. As in the casing 31, the blade ring 34 has the type divided into two portions in the up-down direction, and has a ring shape in which a blade ring upper-half portion 37 and a blade ring lower-half portion 38 are connected by a bolt (not shown). The blade ring 34 is disposed inside the casing 31, and is supported by support portions 39 and 40.

### <Creep Deformation of Blade Ring>

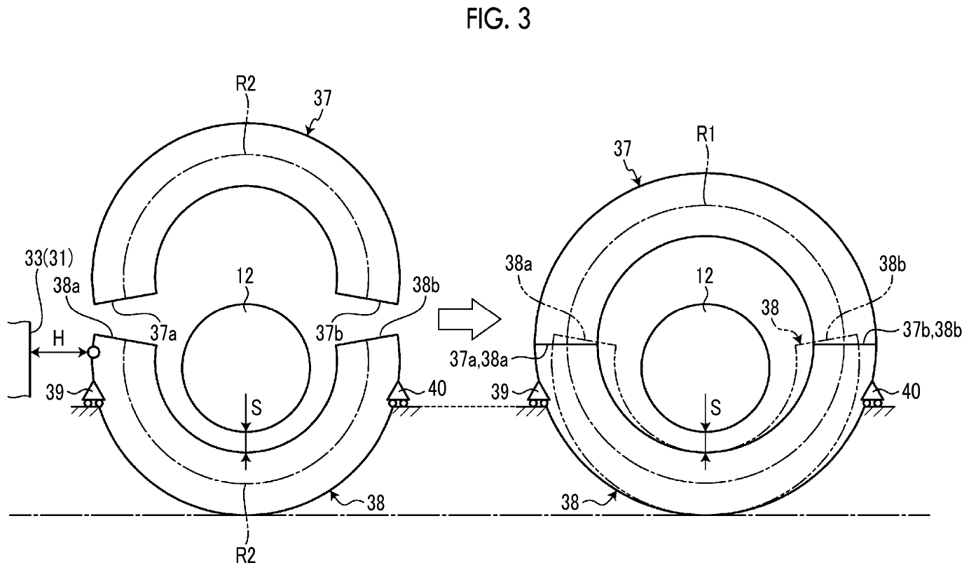

FIG. 3 is a view for describing the amount of the change in the clearance which corresponds to creep deformation of the blade ring.

As shown in FIG. 3, creep deformation occurs in the blade ring 34 during an operation of the steam turbine. Therefore, when the casing 31 is disassembled and the blade ring 34 is subsequently disassembled, the blade ring upper-half portion 37 and the blade ring lower-half portion 38 are released from bolt restraint. Consequently, the creep deformation occurs. That is, the blade ring upper-half portion 37 and the blade ring lower-half portion 38 are slightly curved to an inner peripheral side, and attachment surfaces 37a and 37b and attachment surfaces 38a and 38b are not parallel to each other.

When the blade ring 34 is assembled, in a case where the blade ring upper-half portion 37 and the blade ring lower-half portion 38 are connected by a bolt, the creep deformation is corrected. That is, the blade ring upper-half portion 37 and the blade ring lower-half portion 38 are slightly curved to an outer peripheral side, and the attachment surfaces 37a and 37b and the attachment surfaces 38a and 38b are parallel to each other. However, since the blade ring lower-half portion 38 slightly rises with respect to the rotor 12, a clearance S in a vertical direction in a lower portion on an outer peripheral surface of the rotor 12 and on an inner peripheral surface of the blade ring 34 is reduced and narrowed.

### <Method for Calculating Amount of Change in Clearance of Blade Ring>

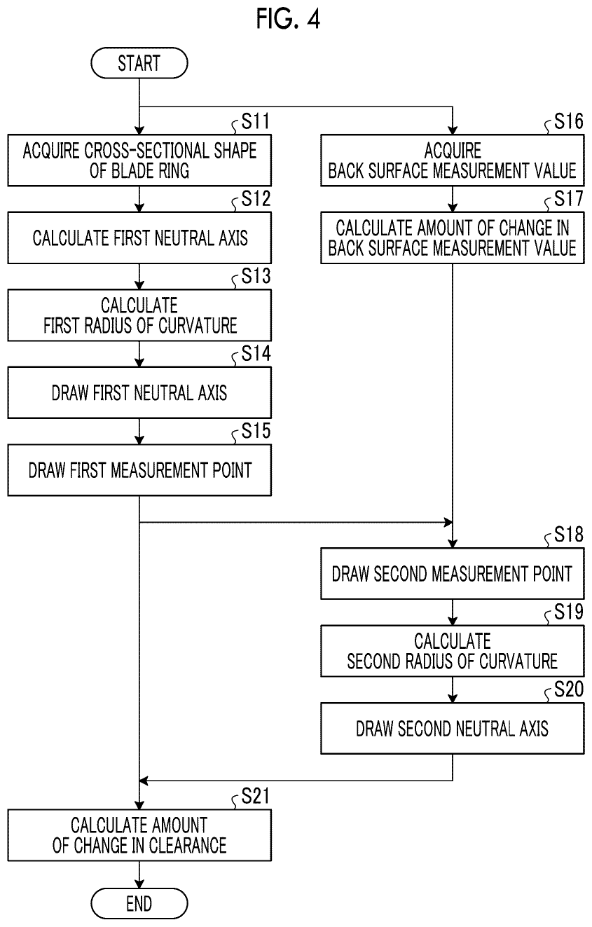

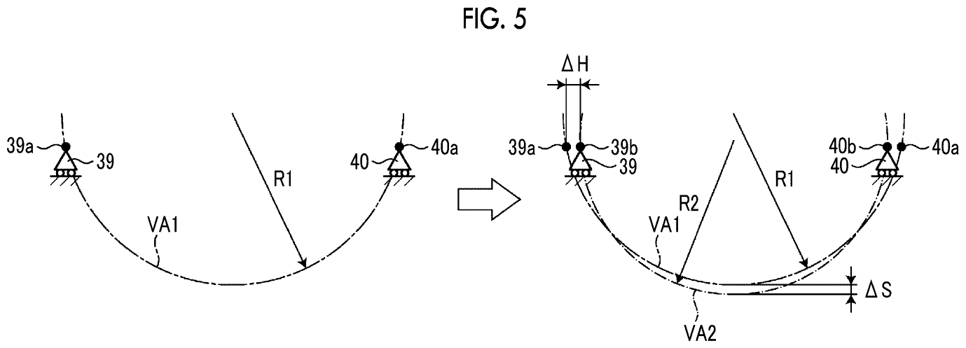

FIG. 4 is a flowchart showing a method for calculating the amount of the change in the clearance of the blade ring of the first embodiment, and FIG. 5 is a view for describing a method for calculating the amount of the change in the clearance of the blade ring.

As shown in FIG. 3, in the method for calculating the amount of the change in the clearance of the blade ring of the first embodiment, the blade ring 34 is configured by connecting the blade ring upper-half portion 37 and the blade ring lower-half portion 38 to have a ring shape, and the amount of the change in the clearance in the vertical direction between the inner peripheral surface of the blade ring 34 and the outer peripheral surface of the rotor (rotary shaft) 12 disposed inside the blade ring 34 is calculated.

The method for calculating the amount of the change in the clearance of the blade ring is processed by a control device. The control device is a controller, and, for example, is realized in such a manner that a central processing unit (CPU) or a micro processing unit (MPU) executes various programs stored in a storage unit by using a RAM as a work region. In addition, the control device is connected to an operation device such as a keyboard, and an operator inputs various command signals to the control device by using an operation device to perform a process of calculating the amount of the change in the clearance of the blade ring.

Here, in the method for calculating the amount of the change in the clearance of the blade ring of the first embodiment, the amount of the change in the clearance is predicted and calculated by using geometric calculation based on the following assumption from a back surface measurement value when the blade ring 34 is disassembled.
1. Back surface measurement is a measurement value in the horizontal direction in the vicinity of the attachment surfaces 37a, 37b, 38a, and 38b. Therefore, a change in the back surface measurement value coincides with a change in the radius of curvature.
2. The inclined attachment surfaces 38a and 38b before the blade ring 34 is assembled become the horizontal attachment surfaces 37a and 37b after the assembly, and a uniform bending moment acts on the whole blade ring upper-half portion 37 or the whole blade ring lower-half portion 38. Therefore, instead of elliptical deformation, deformation shows that the radius of curvature is changed. Therefore, neutral axes of the blade ring upper-half portion 37 and the blade ring lower-half portion 38 of the blade ring 34 after the blade ring 34 is assembled maintain a perfect circle.
3. An arc length of a first neutral axis after the blade ring 34 is assembled coincides with an arc length of a second neutral axis before the blade ring 34 is assembled.

In each step in FIG. 4, Steps S11 to S15 are processes for the blade ring 34 in a first state where the blade ring upper-half portion 37 is connected to the blade ring lower-half portion 38. In addition, Steps S16 to S20 are processes for the blade ring 34 in a second state where the blade ring upper-half portion 37 is detached from the blade ring lower-half portion 38.

As shown in FIG. 4, in Step S11, a cross-sectional shape of the blade ring 34 is acquired. The cross-sectional shape of the blade ring 34 in the first state is acquired from a design value of the blade ring 34 or a measurement value of the blade ring 34 in the first state. In Step S12, the first neutral axis in the blade ring 34 in the first state is calculated. In Step S13, a first radius of curvature is calculated, based on a first neutral axis VA1.

That is, as shown in FIG. 5, in the blade ring 34, the blade ring lower-half portion 38 is supported by two support portions 39 and 40. Here, the first neutral axis VA1 is a position of a cross section having no stress when a bending moment is generated with respect to the blade ring 34 in the first state. In this case, while support points 39a and 40a are located on the first neutral axis VA1, the support portions 39 and 40 support the first neutral axis VA1 of the blade ring 34 in the first state. Here, the support points 39a and 40a of the support portions 39 and 40 with respect to the first neutral axis VA1 are set. A first radius of curvature R1 of the first neutral axis VA1 is calculated.

Referring back to FIG. 4, in Step S14, the first neutral axis VA1 is drawn, and in Step S15, the first measurement point is drawn. That is, as shown in FIG. 5, the first neutral axis VA1 passing through 39a and 40a of the support portions 39 and 40 is drawn. Here, the support points 39a and 40a of the support portions 39 and 40 are first measurement points.

Referring back to FIG. 4, in Step S16, a back surface measurement value of the blade ring 34 in the second state is acquired. That is, as shown in FIG. 3, a back surface measurement value H2 is a length in the horizontal direction between an inner wall surface of the casing 31 (casing upper-half portion 32 and casing lower-half portion 33) and the support point 39b (40b) when the blade ring 34 is in the second state. In this case, the back surface measurement value H2 is acquired by obtaining the back surface measurement values on both sides of the blade ring 34 and averaging the back surface measurement values on both sides. A back surface measurement value H1 (to be described later) is a length in the horizontal direction between the inner wall surface of the casing 31 (casing upper-half portion 32 and casing lower-half portion 33) and the support point 39a (40a) when the blade ring 34 is in the first state, and is a design value or a measurement value.

Referring back to FIG. 4, in Step S17, the amount of a change in the back surface measurement value is calculated. That is, a displacement amount in the horizontal direction between the blade ring 34 in the first state and the blade ring 34 in the second state is acquired as the amount of the change in the back surface measurement value. That is, a deviation between the back surface measurement value H1 of the blade ring 34 in the first state and the back surface measurement value H2 of the blade ring 34 in the second state is calculated as the amount of a change ΔH in the back surface measurement value. In this case, in Step S18, a second measurement point is drawn. In Step S19, a second radius of curvature is calculated. In Step S20, the second neutral axis is drawn.

That is, as shown in FIG. 5, the support points 39b and 40b which are second measurement points are drawn with respect to the first neutral axis VA1 of the blade ring in the first state and the support points 39a and 40a as first measurement points which are drawn in Steps S14 and S15, based on the amount of the change ΔH in the back surface measurement value. A second radius of curvature R2 in which the arc lengths of the support points 39a and 40a and the arc lengths of the support points 39b and 40b in the first neutral axis VA1 coincide with each other is calculated, and the second neutral axis VA2 is drawn.

Referring back to FIG. 4, in Step S21, a change rate of the clearance is calculated. That is, as shown in FIG. 5, the amount of the change ΔH in the back surface measurement value as the displacement amount in the horizontal direction with respect to the blade ring 34 is output as the amount of a change in the clearance ΔS.

### <Method for Adjusting Position of Blade Ring>

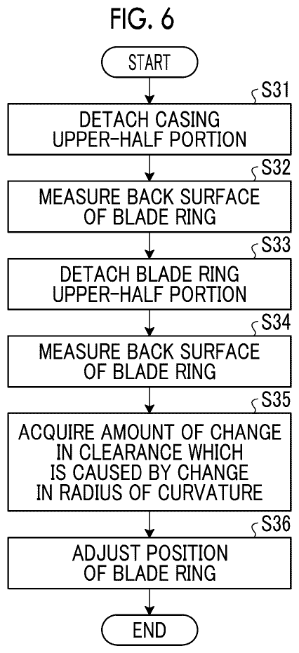

FIG. 6 is a flowchart showing a method for adjusting a position of the blade ring.

As shown in FIGS. 2 and 6, in Step S31, the casing upper-half portion 32 is detached. In Step S32, the back surface measurement value H1 of the blade ring 34 is measured. In Step S33, the blade ring upper-half portion 37 is detached. In Step S34, the back surface measurement value H2 of the blade ring 34 is measured. Then, in Step S35, the amount of the change in the clearance ΔS which is caused by the change in the radius of curvature is acquired by performing the above-described process (Steps S11 to S21). When the blade ring upper-half portion 37 is assembled, the position of the blade ring 34 in the vertical direction is adjusted by using the amount of the change in the clearance ΔS in Step S36.

### Second Embodiment

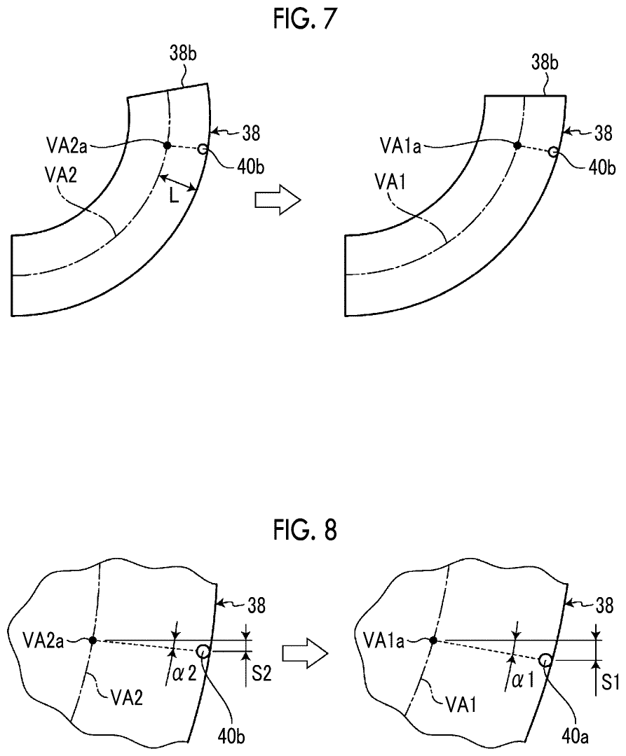

FIG. 7 is a view for describing a method for calculating an amount of a change in a clearance of the blade ring of a second embodiment, and FIG. 8 is an enlarged view for describing the method for calculating the amount of the change in the clearance of the blade ring.

As shown in FIG. 7, in the first embodiment, a case has been described where while the support points 39a and 40a are located on the first neutral axis VA1, the support portions 39 and 40 support the first neutral axis VA1 of the blade ring 34 in the first state. However, in this case, when the support points 39a and 40a (39b and 40b) of the blade ring 34 are separated from the neutral axis, it is necessary to consider a displacement of the blade ring 34 in the vertical direction which is caused by the assembly.

When the support point 40b is on an outer peripheral surface of the blade ring lower-half portion 38 in the blade ring lower-half portion 38 in the second state, a distance L to a point VA2a located at a shortest length from the support point 40b to the second neutral axis VA2 is set. Similarly, in the blade ring lower-half portion 38 in the first state, when the support point 40a is on the outer peripheral surface of the blade ring lower-half portion 38, the distance L to a point VA1a located at the shortest length from the support point 40a to the first neutral axis VA1 is set.

In this case, as shown in FIG. 8, in the blade ring lower-half portion 38 in the second state, a second connection line of the distance L which connects the support point 40b on the outer peripheral surface of the blade ring lower-half portion 38 and the point VA2a on the second neutral axis VA2 with respect to a horizontal line is a line inclined by an angle α2. In addition, in the blade ring lower-half portion 38 in the first state, a first connection line of the distance L which connects the support point 40a on the outer peripheral surface of the blade ring lower-half portion 38 and the point V12a on the first neutral axis VA1 with respect to the horizontal line is a line inclined by an angle α1. Here, a relationship between the angles α1 and α2 of the connection lines is α1<α2 since angles of the attachment surfaces 38a and 38b are changed between the blade ring lower-half portion 38 in the first state and the blade ring lower-half portion 38 in the second state.

As a result, a distance S2 in the vertical direction between the support point 40b and the point VA2a in the blade ring lower-half portion 38 in the second state and a distance S1 in the vertical direction between the support point 40a and the point VA1a in the blade ring lower-half portion 38 in the first state are different from each other. That is, the relationship between the distances S1 and S2 is S1>S2, and when the blade ring lower-half portion 38 is changed from the second state to the first state, the blade ring lower-half portion 38 moves upward in the vertical direction, and the clearance S in the vertical direction in the lower portion of the outer peripheral surface of the rotor 12 and the inner peripheral surface of the blade ring 34 is reduced and narrowed.

When the distance L between the support points 40a and 40b located on the outer peripheral surface of the blade ring lower-half portion 38 and the neutral axes VA1 and VA2, the angle α2 of the second connection line (support point 40b−point VA2a) with respect to the horizontal line, and the amount of the change in an angle Δα from the angle α2 to the angle α1 are defined, the amount of a change in the clearance (correction value of the amount of the change in the clearance) ΔSa can be calculated by the following equation.

$$Δ Sa = S 1 - S 2 = L \times \{ sin ( α 2 + Δ α ) - sin α 2 ]$$

In FIG. 5 in the first embodiment, the amount of the change in the angle Δα can be calculated from an angle formed by a tangent line of the first neutral axis VA1 at the support points 39a and 40a of the blade ring 34 in the first state and a tangent line of the second neutral axis VA2 at the support points 39b and 40b of the blade ring 34 in the second state.

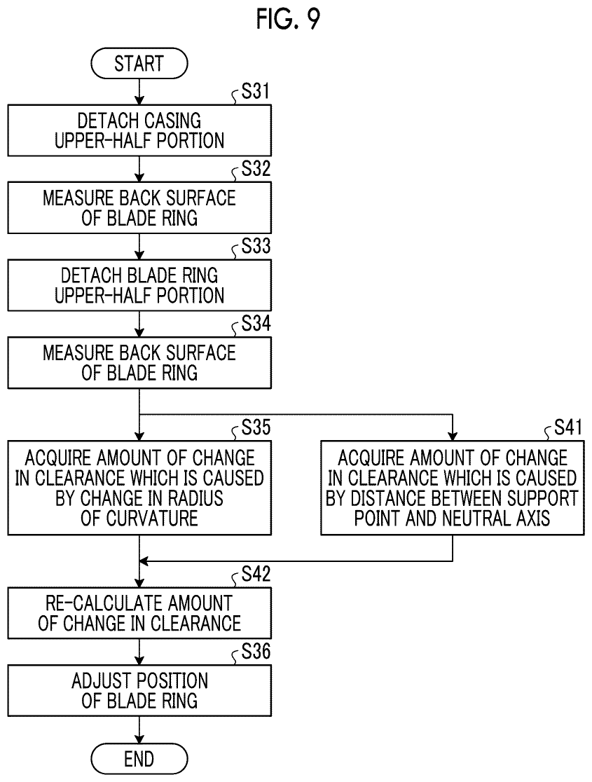

FIG. 9 is a flowchart showing a method for calculating an amount of a change in a clearance of a blade ring of a second embodiment.

As shown in FIG. 9, in Step S31, the casing upper-half portion 32 is detached. In Step S32, the back surface measurement value H1 of the blade ring 34 is measured. In Step S33, the blade ring upper-half portion 37 is detached. In Step S34, the back surface measurement value H2 of the blade ring 34 is measured. Then, in Step S35, the amount of the change in the clearance ΔS which is caused by the change in the radius of curvature is acquired by performing the above-described process (Steps S11 to S21).

In addition, in Step S41, the amount of the change in the clearance ΔSa which is caused by the distance between the support point and the neutral axis is acquired by performing the above-described process. In Step S42, the amount of the change in the clearance ΔS is corrected by the amount of the change in the clearance ΔSa, that is, the amount of the change in the clearance ΔS is corrected through re-calculation by adding the amount of the change in the clearance ΔSa to the amount of the change in the clearance ΔS. Thereafter, when the blade ring upper-half portion 37 is assembled, in Step S36, the position of the blade ring 34 in the vertical direction is adjusted by using the amount of the change in the clearance ΔS.

### Operational Effects of Present Embodiment

A method for calculating the amount of the change in the clearance of the blade ring according to a first aspect includes a step of acquiring the displacement amount in the horizontal direction of the blade ring 34 in the first state where the blade ring upper-half portion 37 is connected to the blade ring lower-half portion 38 and in the second state where the blade ring upper-half portion 37 is detached from the blade ring lower-half portion 38, a step of calculating the second neutral axis of the blade ring 34 in the second state, based on the displacement amount, and a step of calculating the amount of the change in the clearance between the first state and the second state by comparing the first neutral axis of the blade ring 34 in the first state with the second neutral axis.

According to the method for calculating the amount of the change in the clearance of the blade ring in the first aspect, on a premise that the change in the back surface measurement value coincides with the change in the radius of curvature, the neutral axes of the blade ring upper-half portion 37 and the blade ring lower-half portion 38 after the blade ring 34 is assembled maintain a perfect circle, and the arc length of the first neutral axis after the blade ring 34 is assembled coincides with the arc length of the second neutral axis before the blade ring 34 is assembled, it is possible to estimate the amount of the change in the clearance in the vertical direction between the outer peripheral surface of the rotor 12 and the inner peripheral surface of the blade ring 34. Therefore, improved workability of the casing assembly work can be achieved.

According to the method for calculating the amount of the change in the clearance of the blade ring in a second aspect, in the method for calculating the amount of the change in the clearance of the blade ring according to the first aspect, furthermore, the first neutral axis of the blade ring 34 in the first state is calculated, based on the design value or the measurement value of the blade ring 34, and the second neutral axis of the blade ring 34 in the second state is calculated, based on the measurement value of the blade ring 34. In this manner, the first neutral axis and the second neutral axis can be easily calculated.

According to the method for calculating the amount of the change in the clearance of the blade ring in a third aspect, in the method for calculating the amount of the change in the clearance of the blade ring according to the first aspect or the second aspect, furthermore, the two support points 39a, 39b, 40a, and 40b for supporting the blade ring 34 from below are assumed that the two support points 39a, 39b, 40a, and 40b pass through the first neutral axis or the second neutral axis. In this manner, the amount of the change in the clearance can be easily estimated.

According to the method for calculating the amount of the change in the clearance of the blade ring in a fourth aspect, in the method for calculating the amount of the change in the clearance of the blade ring according to any one of the first to third aspects, furthermore, the correction value of the amount of the change in the clearance in the vertical direction between the first state and the second state is calculated, based on the angle of the first connection line connecting the support points 39a, 39b, 40a, and 40b for supporting the blade ring 34 from below and the first neutral axis with the shortest length and the angle of the second connection line connecting the support points 39a, 39b, 40a, and 40b and the second neutral axis with the shortest length, and the amount of the change in the clearance is corrected by using the correction value of the amount of the change in the clearance. In this manner, the amount of the change in the clearance can be calculated with high accuracy.

According to the method for adjusting the position of the blade ring in a fifth aspect, when the blade ring upper-half portion 37 is assembled with the blade ring lower-half portion 38, the position of the blade ring 34 in the vertical direction is adjusted, based on the amount of the change in the clearance which is calculated by the method for calculating the amount of the change in the clearance of the blade ring. In this manner, the position of the blade ring 34 can be adjusted with high precision.

### REFERENCE SIGNS LIST

10: Steam turbine (rotary machine)
11: Casing
12: Rotor (rotary shaft)
13: Stator vane
14: Rotor blade
31: Casing
32: Casing upper-half portion
33: Casing lower-half portion
34: Blade ring
35: Outer ring
36: Inner ring
37: Blade ring upper-half portion
38: Blade ring lower-half portion
39, 40: Support portion
39a, 39b, 40a, 40b: Support point

1. A method for calculating an amount of a change in a clearance of a blade ring, in which a blade ring having a ring shape is configured by connecting a blade ring upper-half portion and a blade ring lower-half portion and the amount of the change in the clearance in a vertical direction between an inner peripheral surface of the blade ring and an outer peripheral surface of a rotary shaft disposed inside the blade ring is calculated, the method comprising:
a step of acquiring a displacement amount in a horizontal direction of the blade ring in a first state where the blade ring upper-half portion is connected to the blade ring lower-half portion and a second state where the blade ring upper-half portion is detached from the blade ring lower-half portion;
a step of calculating a second neutral axis of the blade ring in the second state, based on the displacement amount; and
a step of calculating the amount of the change in the clearance between the first state and the second state by comparing a first neutral axis of the blade ring in the first state with the second neutral axis.

2. The method for calculating an amount of a change in a clearance of a blade ring according to claim 1,
wherein the first neutral axis of the blade ring in the first state is calculated, based on a design value or a measurement value of the blade ring, and the second neutral axis of the blade ring in the second state is calculated, based on the measurement value of the blade ring.

3. The method for calculating an amount of a change in a clearance of a blade ring according to claim 1,
wherein two support points for supporting the blade ring from below pass through the first neutral axis in the first state and pass through the second neutral axis in the second state.

4. The method for calculating an amount of a change in a clearance of a blade ring according to claim 1,
wherein a correction value of the amount of the change in the clearance in the vertical direction between the first state and the second state is calculated, based on an angle of a first connection line connecting a support point for supporting the blade ring from below and the first neutral axis with a shortest length, and an angle of a second connection line connecting the support point and the second neutral axis with a shortest length, and the amount of the change in the clearance is corrected by using the correction value of the amount of the change in the clearance.

5. A method for adjusting a position of a blade ring,
wherein when a blade ring upper-half portion is assembled with a blade ring lower-half portion, a position of the blade ring in a vertical direction is adjusted, based on the amount of the change in the clearance which is calculated by the method for calculating an amount of a change in a clearance of a blade ring according to claim 1.
